(19) United States
(12) Patent Application Publication
(10) Pub. No.: US 2026/0121487 A1
(43) Pub. Date: Apr. 30, 2026

(54) MOTOR SYSTEM AND MOTOR

(71) Applicants: Mitsubishi Electric Corporation, Tokyo (JP); TOKYO DENKI UNIVERSITY, Tokyo (JP)

(72) Inventors: Masahito MIYOSHI, Tokyo (JP); Yuichiro NAKAMURA, Tokyo (JP); Eigo TOTOKI, Tokyo (JP); Hiroya SUGIMOTO, Tokyo (JP)

(73) Assignees: Mitsubishi Electric Corporation, Tokyo (JP); TOKYO DENKI UNIVERSITY, Tokyo (JP)

(21) Appl. No.: 19/119,422

(22) PCT Filed: Oct. 18, 2022
(86) PCT No.: PCT/JP2022/038821

§ 371 Date: Apr. 9, 2025

(51) Int. Cl. H02K 11/20; H02K 1/14; H02K 3/18

(52) U.S. Cl. CPC H02K 11/20; H02K 1/14; H02K 3/18

(57) ABSTRACT

A motor system includes a motor and a control unit that controls the motor. The motor includes: a rotor in which a magnetic flux generator is disposed; a stator including a back yoke and a plurality of teeth disposed side by side at intervals in a rotation direction of the rotor; a winding wound around the stator; and a plurality of magnetic sensors provided in slots that are spaces between adjacent ones of the teeth. The control unit includes a computation unit that obtains a rotation angle and/or an eccentricity of the rotor based on signals of the plurality of magnetic sensors, and a signal of the magnetic sensor used by the computation unit is a signal of the magnetic sensor provided in the slot in which the windings on both sides have the same phase and directions of energization opposite to each other.

### FIELD

The present disclosure relates to a motor system and a motor that detect the rotation angle and/or the eccentricity of the motor using a magnetic sensor.

### BACKGROUND

Motors generate torque by an interaction between a current and a magnetic flux density. In order to detect the rotation angle or the eccentricity of a motor, there is a method in which a magnetic flux generator that generates a magnetic flux such as a permanent magnet or a field winding is disposed in a rotor, and a magnetic flux density from the rotor is measured by a magnetic sensor and is used for computation.

For example, Patent Literature 1 discloses a motor including a rotor in which a permanent magnet is disposed and a magnetic sensor, and having a function of detecting the rotation angle of the motor. In the motor disclosed in Patent Literature 1, the magnetic sensor is disposed between a plurality of teeth around which windings are wound.

### CITATION LIST

### Patent Literature

Patent Literature 1: Japanese Patent Application Laid-open No. 2016-188700

### SUMMARY OF INVENTION

### Problem to be Solved by the Invention

However, according to the motor disclosed in Patent Literature 1, the magnetic sensor may detect not only the magnetic flux generated by the permanent magnet disposed in the rotor but also the magnetic flux generated in the winding upon energization. This causes a problem that the signal of the magnetic sensor changes depending on the energization of the winding, and the detection error of the rotation angle or the eccentricity may increase.

The present disclosure has been made in view of the above, and an object thereof is to provide a motor system capable of reducing the detection error of information of a detection target that is the rotation angle and/or the eccentricity.

### Means to Solve the Problem

In order to solve the above-described problems and achieve the object, a motor system according to the present disclosure comprises a motor and a control unit to control the motor, the motor includes: a rotor in which a magnetic flux generator that generates a magnetic flux is disposed; a stator including a back yoke disposed facing the rotor, and a plurality of teeth protruding from the back yoke toward the rotor and disposed side by side at intervals in a rotation direction of the rotor; a winding wound around the stator; and a plurality of magnetic sensors provided in slots that are spaces between adjacent ones of the teeth to measure a magnetic flux density. The control unit includes a computation unit to obtain a rotation angle and/or an eccentricity of the rotor based on signals of the plurality of magnetic sensors, and a signal of the magnetic sensor used by the computation unit is a signal of the magnetic sensor provided in the slot in which the windings on both sides have the same phase and directions of energization opposite to each other.

### Effects of the Invention

The present disclosure can achieve the effect of providing a motor system capable of reducing the detection error of information of a detection target that is the rotation angle and/or the eccentricity.

### BRIEF DESCRIPTION OF DRAWINGS

FIG. 1 is a diagram illustrating a configuration of a motor system according to the first embodiment.

FIG. 2 is a diagram illustrating a cross-sectional configuration of the motor according to the first embodiment.

FIG. 3 is a partially enlarged diagram of FIG. 2.

FIG. 4 is a diagram illustrating a configuration of an XZ cross section of the motor according to the first embodiment.

FIG. 5 is a diagram illustrating a correlation between the positional deviation amount in the rotation axis direction between the rotor and the magnetic sensor and the magnitude of a signal detected by the magnetic sensor.

FIG. 6 is a diagram illustrating a relationship between the inclination of the rotor and the magnitude of the detection signal of the magnetic sensor.

FIG. 7 is a diagram illustrating the relationship between the position of the magnetic sensor and the magnetic flux density in the radial direction.

FIG. 8 is a diagram illustrating a cross-sectional configuration of a motor according to a modification of the first embodiment.

FIG. 9 is a diagram illustrating a cross-sectional configuration of a motor according to the second embodiment.

FIG. 10 is a diagram illustrating a cross-sectional configuration of a motor according to a modification of the second embodiment.

FIG. 11 is a diagram illustrating a cross-sectional configuration of a motor according to the third embodiment.

FIG. 12 is a diagram illustrating a cross-sectional configuration of a motor according to a modification of the third embodiment.

FIG. 13 is a diagram illustrating a configuration of a control unit according to the fourth embodiment.

FIG. 14 is a diagram illustrating an example of a relationship between the energization amount to the winding and the signal of the magnetic sensor.

FIG. 15 is a diagram for explaining the correction unit illustrated in FIG. 13.

### DESCRIPTION OF EMBODIMENTS

Hereinafter, a motor system and a motor according to embodiments of the present disclosure will be described in detail with reference to the drawings.

### First Embodiment

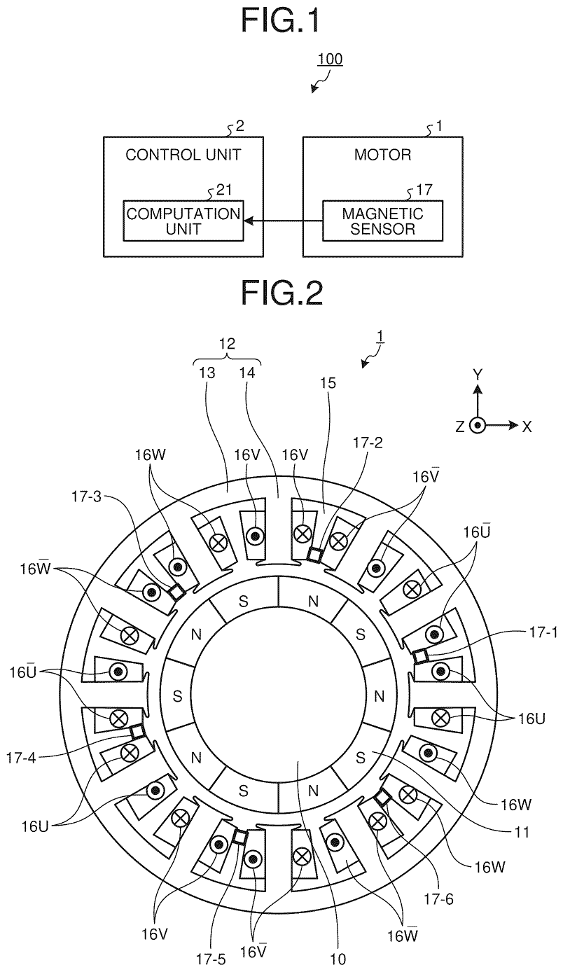

FIG. 1 is a diagram illustrating a configuration of a motor system 100 according to the first embodiment. The motor system 100 includes a motor 1 and a control unit 2. The motor 1 is a device that converts electric energy into mechanical energy. Specifically, the motor 1 outputs a rotational motion using a force due to an interaction between a magnetic field and a current. The control unit 2 controls the motor 1.

A magnetic sensor 17 for measuring a magnetic flux density is attached to the motor 1. The magnetic sensor 17 outputs a signal indicating the measured magnetic flux density to the control unit 2. The control unit 2 includes a computation unit 21 that computes the rotation angle and the eccentricity of the motor 1 based on a signal of the magnetic sensor 17. The control unit 2 can control the motor 1 based on the detected rotation angle and eccentricity. Although the magnetic sensor 17 is represented by one block in FIG. 1, the motor 1 includes a plurality of magnetic sensors 17. Although the control unit 2 detects the rotation angle and the eccentricity here, the control unit 2 detects the rotation angle and/or the eccentricity. That is, the control unit 2 may detect only the rotation angle, only the eccentricity, or both the rotation angle and the eccentricity.

FIG. 2 is a diagram illustrating a cross-sectional configuration of the motor 1 according to the first embodiment. Given that the direction of the rotation axis of the motor 1 is the 2-axis direction, FIG. 2 illustrates an XY cross section. The motor 1 includes a rotor 10, a permanent magnet 11 disposed in the rotor 10, and a stator 12. The rotor 10 has a columnar shape whose longitudinal direction is the Z-axis direction, and the permanent magnet 11 is disposed on the outer circumference. The permanent magnet 11 of the rotor 10 is an example of a magnetic flux generator that generates a magnetic flux. The magnetic flux generator may be not only the permanent magnet 11 but also a field winding. Here, the magnetic flux generated by the permanent magnet 11 contributes to the generation of the torque of the motor 1 and is also used for the detection of the rotation angle and the eccentricity. Therefore, it is possible to detect the rotation angle and the eccentricity while reducing the increase in the volume and mass of the entire motor 1. The stator 12 includes a cylindrical back yoke 13 disposed facing the rotor 10 with a gap from the rotor 10, and a plurality of teeth 14 protruding from the back yoke 13 toward the rotor 10. The plurality of teeth 14 are disposed at intervals in the circumferential direction. A space between adjacent teeth 14 is referred to as a slot 15.

The number of teeth 14 and slots 15 of the stator 12 is 12, and the number of poles of the permanent magnet 11 of the rotor 10 is 10. Therefore, the motor 1 has 10 poles and 12 slots.

The motor 1 also includes a winding 16 wound around each of the plurality of teeth 14. The U-phase winding 16 is denoted by 16U or 16U (bar). U (bar) represents U with a bar above U. Hereinafter, similarly, those with a bar above a reference sign may be represented by adding (bar) after the reference sign. Here, the winding 16U (bar) means that the direction of energization is opposite to that of the winding 16U. Here, the winding 16U is wound such that an outward magnetic flux is generated in the tooth 14 around which the winding 16U is wound when a positive current is applied, and the winding 16U (bar) is wound such that an inward magnetic flux is generated in the tooth 14 around which the winding 16U (bar) is wound when a positive current is applied.

The motor 1 includes a winding 16U, a winding 16U (bar), a winding 16V (bar), a winding 16V, a winding 16W, a winding 16W (bar), a winding 16U (bar), a winding 16U, a winding 16V, a winding 16V (bar), a winding 16W (bar), and a winding 16W in counterclockwise order from the 3:00 direction on the paper of FIG. 2 such that the motor 1 has a 12-slot shape and generates a 10-pole magnetic field.

The magnetic sensor 17 is a sensor such as a Hall element, and can convert a magnetic field or a magnetic flux density into a voltage and measure the voltage. The motor 1 includes six magnetic sensors 17. In the case of distinguishing the plurality of magnetic sensors 17, a hyphen and a number are added after the reference number 17, and the magnetic sensors are referred to as magnetic sensors 17-1 to 17-6. The magnetic sensor 17 may be a digital output system in which the output changes with a threshold as a boundary, or may be an analog output system in which the output changes linearly in proportion to the value of the magnetic flux density. In the digital output system, the range of the rotation angle and the eccentricity can be known, and in the analog output system, the values of the rotation angle and the eccentricity can be directly known. In addition, in the analog output system, the influence of the magnetic flux due to energization to the winding 16 directly appears in the signal of the magnetic sensor 17, which is more likely to cause a problem than in the digital output system. In the following description, it is assumed that the magnetic sensor 17 is the analog output system. In the air, the magnetic field and the magnetic flux density are proportional to each other. Hereinafter, the detection target of the magnetic sensor 17 is mainly described as the magnetic flux density, but may be the magnetic field.

The magnetic sensor 17 is provided in the slot 15 in which the phases of the windings 16 wound around the teeth 14 on both sides are the same and the directions of energization are opposite to each other. In other words, the magnetic sensor 17 is provided between the windings 16 having the same phase and directions of energization opposite to each other. Specifically, the magnetic sensor 17-1 is provided between the winding 16U and the winding 16U (bar). The magnetic sensor 17-2 is provided between the winding 16V and the winding 16V (bar). The magnetic sensor 17-3 is provided between the winding 16W and the winding 16W (bar). The magnetic sensor 17-4 is provided between the winding 16U and the winding 16U (bar). The magnetic sensor 17-5 is provided between the winding 16V and the winding 16V (bar). The magnetic sensor 17-6 is provided between the winding 16W and the winding 16W (bar).

Although six magnetic sensors 17-1 to 17-6 are illustrated in FIG. 2, the number of magnetic sensors 17 is not particularly limited as long as the motor 1 includes a plurality of magnetic sensors. In order to calculate the angle from the magnetic sensor 17, it is only necessary to detect waveforms of magnetic flux densities on at least two sinusoidal waves having different phases with the rotation of the rotor 10. Therefore, at least two magnetic sensors 17 are required.

Given that the angle of the rotor 10, that is, the rotation angle, is θ, if information of the waveform X=cos θ and the waveform Y=sin θ can be computed from the magnetic sensor 17, the rotation angle θ can be calculated using Formula (1) below. Here, tan⁻¹ means arctangent.

$$Formula 1$$

$$θ = {tan}^{- 1} \frac{Y}{X} \qquad ( 1 )$$

The waveforms cos θ and sin θ can be obtained directly from two magnetic sensors 17 disposed at positions electrically different in phase by 90°. In addition, the waveforms cos θ and sin θ can also be calculated by performing four arithmetic operations including the three-to-two-phase conversion described later from signals of three or more magnetic sensors 17. Furthermore, even in a case where only two magnetic sensors 17 are disposed and the electrical phase difference is not 90°, the waveforms of cos θ and sin θ can be obtained by performing four arithmetic operations from two signals. For example, suppose that a waveform X=cos θ and a waveform Y′=cos(θ-60°) are given. In this case, the waveform Y=sin θ can be obtained by computing Formula (2) below.

$$Formula 2$$

$$Y = \frac{2}{\sqrt{3}} {Y}^{′} - \frac{1}{\sqrt{3}} X \qquad ( 2 )$$

The windings 16 of the same phase may be all connected in series or partially connected in parallel. When all the windings 16 of the same phase are connected in series, the values of the currents flowing through all the windings 16 of the same phase are the same. Even when the windings 16 of the same phase are partially connected in parallel, if the current circulating in the parallel circuit is small, the value of the current flowing through each winding 16 can be considered to be the same. The three phases of the U phase, the V phase, and the W phase may be connected by Y connection or A connection.

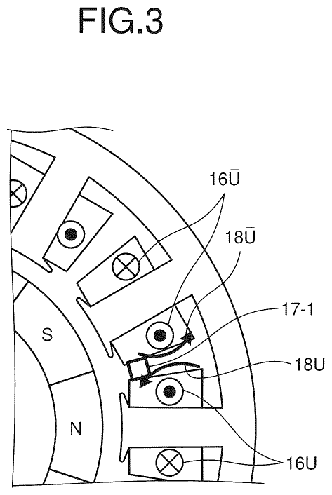

FIG. 3 is a partially enlarged diagram of FIG. 2. With reference to FIG. 3, a description will be given of a principle of canceling a magnetic flux density generated by energization from the winding 16 when the magnetic sensor 17 is provided in the slot 15 in which the phases of the windings 16 wound around the teeth 14 on both sides are the same and the directions of energization are opposite to each other. FIG. 3 illustrates a state in which a positive current flows through the winding 16U. Due to the right-hand screw rule, magnetic flux densities are generated around the winding 16U and the winding 16U (bar). The magnitude of the generated magnetic flux density is generally proportional to the current and inversely proportional to the distance from the winding 16. Therefore, as the current flowing through the winding 16 increases, and as the magnetic sensor 17 is closer to the winding 16, the influence of the magnetic flux density generated by the winding 16 on the magnetic sensor 17 increases.

However, the magnetic sensor 17 is provided in the slot 15 in which the phases of the windings 16 wound around the teeth 14 on both sides are the same and the directions of energization are opposite to each other. That is, the windings 16 located on both sides of the magnetic sensor 17 have the same phase and directions of energization opposite to each other. Therefore, the magnetic flux density generated at the place where the magnetic sensor 17 is disposed is the sum of the magnetic flux densities generated by the two windings 16 disposed on both sides of the magnetic sensor 17. Specifically, the magnetic sensor 17-1 illustrated in FIG. 3 is affected by a magnetic flux 18U generated from the winding 16U and a magnetic flux 18U (bar) generated from the winding 16U (bar). At this time, when the magnetic sensor 17-1 is disposed just at the intermediate position between the winding 16U and the winding 16U (bar), the magnetic flux 18U and the magnetic flux 18U (bar) have the same magnitude and opposite directions in the radial R direction. Therefore, the influence of the winding 16U on the magnetic sensor 17-1 is canceled by the influence of the winding 16 (bar) on the magnetic sensor 17-1. Although the magnetic sensor 17-1 has been described here, the same applies to the other magnetic sensors 17-2 to 17-6. At the position where the magnetic sensors 17-1 to 17-6 are disposed, the magnetic flux density does not change even when the energization amount of the winding 16 increases or decreases, and only the magnetic flux from the permanent magnet 11 of the rotor 10 appears. Therefore, the magnetic sensor 17 can detect only the magnetic flux from the permanent magnet 11 of the rotor 10.

In the above description, the motor 1 is a radial gap motor in which the rotor 10 and the stator 12 face each other in the radial direction. An axial gap motor in which the rotor 10 and the stator 12 face each other in the rotation axis direction has a similar effect. In the case of the axial gap motor, the direction of the magnetic flux from the rotor 10 is mainly the rotation axis direction. In the stator 12, the direction of the magnetic flux from the windings 16 on both sides of the magnetic sensor 17 is also mainly the rotation axis direction. Also in the axial gap motor, if the magnetic sensor 17 is disposed between two windings 16 having the same phase and directions of energization opposite to each other, the magnetic fluxes from the windings 16 on both sides have the same magnitude and opposite directions, and cancel each other. Therefore, the magnetic sensor 17 can detect only the magnetic flux from the permanent magnet 11 disposed in the rotor 10.

As described above, by disposing the magnetic sensor 17 in the slot 15 in which the phases of the windings 16 wound around the teeth 14 on both sides are the same and the directions of energization are opposite to each other, it is not necessary to consider the influence of the windings 16 on the magnetic sensor 17. Therefore, it is not necessary to increase the distance between the magnetic sensor 17 and the winding 16. Therefore, it is possible to dispose the magnetic sensor 17 near the winding 16. Since the limited space of the slot 15 can be allocated to the winding 16 instead of the space for taking the distance between the winding 16 and the magnetic sensor 17, the resistance of the winding 16 can be reduced, and the copper loss during operation can be reduced. In order to significantly reduce the influence from the winding, a detection-dedicated permanent magnet for detecting the rotation angle and the eccentricity may be prepared at a position physically away from the motor 1 and the winding 16, and a magnetic flux of the detection-dedicated permanent magnet may be detected. However, there is no need to take such a measure. As a result, with the output and loss being the same, the size and mass of the entire motor 1 can be reduced.

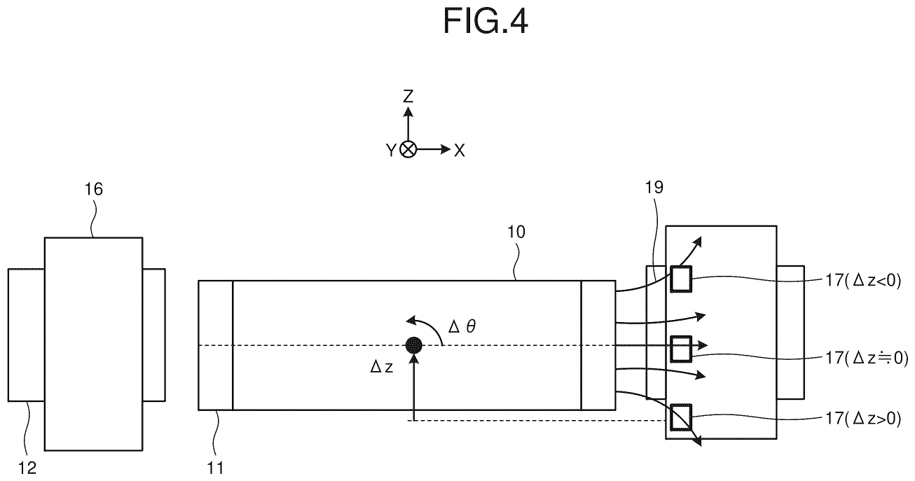

FIG. 4 is a diagram illustrating a configuration of an XZ cross section of the motor 1 according to the first embodiment. Here, the XZ cross section is a cross section including the rotation axis and the radial R direction. Conventionally, in order to reduce the influence of the magnetic flux from the winding 16, there has been a method of shifting the position of the magnetic sensor 17 in the rotation axis direction, that is, the Z-axis direction. However, when the position of the magnetic sensor 17 is shifted in the rotation axis direction, the magnitude of the magnetic flux 19 from the permanent magnet 11 of the rotor 10 is also reduced, so that a signal to noise ratio (SNR) is less likely to decrease as a result. The magnetic sensor 17 of the motor 1 may be disposed at a position away from the winding 16 in the rotation axis direction, but may be disposed at the center position of the rotor 10 in the rotation axis direction as illustrated as Δz≈0 in FIG. 4. This is because, as described above, by disposing the magnetic sensor 17 in the slot 15 in which the phases of the windings 16 wound around the teeth 14 on both sides are the same and the directions of energization are opposite to each other, the influence from the windings 16 on both sides is canceled at any position in the rotation axis direction. Here, Δz represents a positional deviation amount from the center position of the rotor 10 in the rotation axis direction of each magnetic sensor 17. FIG. 4 illustrates the magnetic sensor 17 with Δz≈0, the magnetic sensor 17 with Δz<0, and the magnetic sensor 17 with Δz>0.

When the rotor 10 floats in the air due to magnetic levitation, there is an error in assembly, or vibration occurs in the rotor 10 or the stator 12, the relative position of the rotor 10 with respect to the magnetic sensor 17 may deviate in the rotation axis direction or the inclination direction. At this time, at the position shifted from the permanent magnet 11 of the rotor 10 in the axial direction, the magnitude of the signal detected by the magnetic sensor 17 may greatly vary due to the displacement of the rotor 10, the shift of the location of the magnetic sensor 17, and the like. When the magnetic sensor 17 is disposed at a position shifted from the rotor 10 in the axial direction, if the distance between the rotor 10 and the magnetic sensor 17 increases, the magnitude of the signal of the magnetic sensor 17 decreases, and if the distance between the rotor 10 and the magnetic sensor 71 decreases, the magnitude of the signal of the magnetic sensor 17 increases.

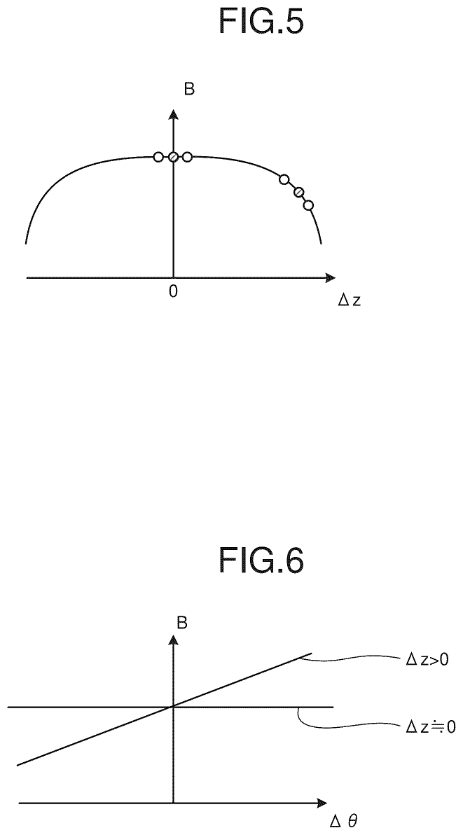

FIG. 5 is a diagram illustrating a correlation between the positional deviation amount Δz in the rotation axis direction between the rotor 10 and the magnetic sensor 17 and the magnitude of a signal detected by the magnetic sensor 17. The horizontal axis in FIG. 5 represents the positional deviation amount Δz in the rotation axis direction between the rotor 10 and the magnetic sensor 17, and the vertical axis in FIG. 5 represents the magnitude B of the detection signal of the magnetic sensor 17. The magnitude B of the detection signal of the magnetic sensor 17 has a maximum value in the vicinity of Δz=0, and a change in the magnitude B of the detection signal is small in the vicinity of Δz≈0. On the other hand, when the absolute value of the positional deviation amount Δz increases, a slight change in the value of Δz causes a large change in the magnitude B of the detection signal of the magnetic sensor 17.

FIG. 6 is a diagram illustrating a relationship between the inclination 40 of the rotor 10 and the magnitude B of the detection signal of the magnetic sensor 17. In a case where the magnetic sensor 17 is disposed at a position where Δz≈0, even when the rotor 10 is inclined and the value of Δθ changes, the distance between the magnetic sensor 17 and the permanent magnet 11 hardly changes, and thus, the magnitude B of the detection signal of the magnetic sensor 17 also does not change. On the other hand, in a case where the magnetic sensor 17 is disposed at a position where Δz>0, when the rotor 10 is inclined and the absolute value of 40 changes, the distance between the magnetic sensor 17 and the permanent magnet 11 changes.

In the motor 1, the magnetic sensor 17 is disposed between the windings 16 having the same phase and directions of energization opposite to each other. If such a condition is satisfied, by disposing the magnetic sensor 17 in the vicinity of Δz≈0, which is the center position of the rotor 10, in the rotation axis direction of the motor 1, it is possible to reduce the influence of the magnetic flux from the winding 16 while increasing the magnitude of the magnetic flux from the permanent magnet 11 of the rotor 10. As a result, the SNR can be improved at each stage as compared with the conventional technique in which the magnetic sensor 17 is disposed at a position shifted from the center position of the rotor 10 in the rotation axis direction. In addition, if the magnetic sensor 17 is disposed in the vicinity of Δz≈0, which is the central portion in the rotation axis direction of the motor 1, even when the rotor 10 and the magnetic sensor 17 are relatively shifted in the axial direction or the inclination direction, the magnitude B of the detection signal of the magnetic sensor 17 hardly changes. Therefore, the magnetic sensor 17 can detect the magnetic flux robustly against positional displacement, vibration, and the like of the magnetic sensor 17 and the rotor 10. In addition, by disposing a plurality of magnetic sensors 17 at the position of Δz>0 and the position of Δz<0, it is possible to detect the position in the axial direction and the position in the inclination direction of the rotor 10 while reducing the influence of the magnetic flux from the winding 16 due to energization.

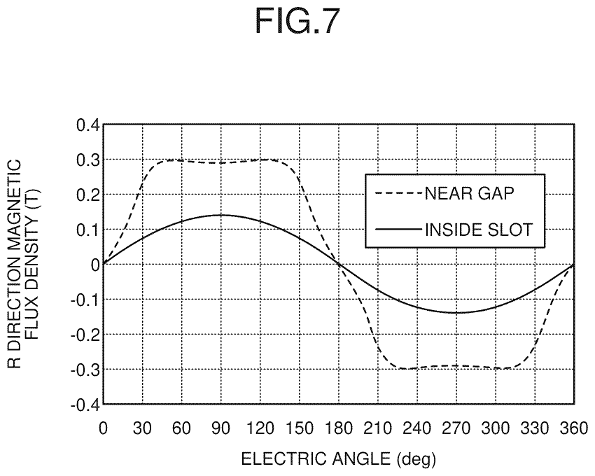

FIG. 7 is a diagram illustrating the relationship between the position of the magnetic sensor 17 and the magnetic flux density in the radial R direction. In FIG. 7, the magnetic flux density in the radial R direction when the magnetic sensor 17 is disposed near the rotor 10, that is, near the gap between the rotor 10 and the stator 12, is indicated by a broken line. In FIG. 7, the magnetic flux density in the radial R direction when the magnetic sensor 17 is disposed away from the gap and inside the slot 15 is indicated by a solid line. The position away from the gap means the positive radial R direction side in the inner rotor type in which the rotor 10 is inside the stator 12 as illustrated in FIG. 2, and means the negative radial R direction in the outer rotor type in which the rotor 10 is outside the stator 12. The closer the magnetic sensor 17 is to the gap, the more the magnetic flux from the permanent magnet 11 is picked up, and the larger the obtained signal. However, the magnetic flux from the permanent magnet 11 includes not only a fundamental wave component but also many harmonic components. Therefore, in a case where the magnetic sensor 17 is disposed at a position close to the gap and the signal of the magnetic sensor 17 contains many harmonic components, the signal detected by the magnetic sensor 17 is not an ideal sine wave as indicated by the broken line in FIG. 7, and the angle error increases.

If the magnetic sensor 17 is disposed away from the gap in the direction inside the slot 15, that is, closer to the back yoke 13 than the tip of the tooth 14, the fundamental wave component decreases, but the spatial harmonic component that causes the angle error significantly decreases. Therefore, the signal detected by the magnetic sensor 17 approaches a sine wave, and the angle error due to the spatial harmonic from the permanent magnet 11 is reduced. Here, disposing the magnetic sensor 17 inside the slot 15 results in the magnetic sensor 17 being closer to the winding 16 of the stator 12 and being susceptible to the influence of the magnetic flux from the winding 16. However, as described above, if the magnetic sensor 17 is disposed between the windings 16 having the same phase and directions of energization opposite to each other, the influence of the magnetic flux from one winding 16 can be canceled by the influence of the magnetic flux from the other winding 16, so that an increase in the influence of the magnetic flux from the winding 16 can be reduced. Therefore, by disposing the magnetic sensor 17 between the windings 16 having the same phase and directions of energization opposite to each other inside the slot 15, it is possible to achieve both the reduction of the influence of the spatial harmonic from the permanent magnet 11 and the reduction of the influence of the magnetic flux from the winding 16.

Next, signals detected by the respective magnetic sensors 17 when the magnetic sensors 17 are disposed as illustrated in FIG. 2 with 10 poles and 12 slots, and a post-processing method performed by the computation unit 21 of the control unit 2 using these signals will be described using formulas.

The number of pole pairs is five. The value of the number of pole pairs “5” is larger than “4”, which is ⅓ of the number of slots “12”, and smaller than “8”, which is ⅔ of the number of slots “12”.

Here, signals of the six magnetic sensors 17-1 to 17-6 are denoted by S₁ to S₆, respectively. That is, the signal of the n-th magnetic sensor 17-n is Sₙ. Sₙ is expressed by Formula (3) below. Here, B₀ is the amplitude of the fundamental wave of the magnetic flux from the permanent magnet 11 of the rotor 10 when not eccentric in the radial R direction, p is the number of pole pairs of the permanent magnet 11, θ is the angle of the rotor 10, and αₙ is the angle at which the magnetic sensor 17 is disposed. In addition, b is a coefficient representing the ratio of the third-order harmonic component to the fundamental wave of the permanent magnet 11, r is the magnitude of eccentricity of the rotor 10, φ is the direction of eccentricity of the rotor 10 with the X-axis direction as a reference of 0 degree, and Rₙ and Lₙ are magnetic flux densities generated by energization of the windings 16 located on both sides of the n-th magnetic sensor 17-n.

$$Formula 3$$

$${S}_{n} = {B}_{0} [ cos p ( θ − {α}_{n} ) + b cos 3 p ( θ − {α}_{n} ) ] [ 1 + r cos ( φ − {α}_{n} ) ] + {R}_{n} + {L}_{n} \qquad ( 3 )$$

Given that the displacement amount of the rotor 10 in the X direction is x and the displacement amount of the rotor 10 in the Y direction is y, relationships of Formulas (4) and (5) below are established between each of x and y and r and φ.

$$Formula 4$$

$$x = r cos φ \qquad ( 4 )$$

$$Formula 5$$

$$y = r sin φ \qquad ( 5 )$$

In FIG. 2, with the direction of 3:00 on the paper being 0°, α₁=15°, α₂=α₁+60°, α₃=α₁+120°, α₄4=α₁+180°, α₅=α₁+240°, and α₆=α₁+300° are set. In addition, p=5. Using the relationship of α₂=α₅−180° and α₆=α₃+180°, S₁ to S₆ are expressed by Formulas (6) to (11) below, respectively.

$$Formula 6$$

$${S}_{1} = {B}_{0} [ cos p ( θ − {α}_{1} ) + b cos 3 p ( θ − {α}_{1} ) ] [ 1 + r cos ( φ − {α}_{1} ) ] + {R}_{1} + {L}_{1} \qquad ( 6 )$$

$$Formula 7$$

$${S}_{2} = - {B}_{0} [ cos p ( θ − {α}_{5} ) + b cos 3 p ( θ − {α}_{5} ) ] [ 1 + r cos ( φ − {α}_{5} ) ] + {R}_{2} + {L}_{2} \qquad ( 7 )$$

$$Formula 8$$

$${S}_{3} = - {B}_{0} [ cos p ( θ − {α}_{3} ) + b cos 3 p ( θ − {α}_{3} ) ] [ 1 + r cos ( φ − {α}_{3} ) ] + {R}_{3} + {L}_{3} \qquad ( 8 )$$

$$Formula 9$$

$${S}_{4} = - {B}_{0} [ cos p ( θ − {α}_{1} ) + b cos 3 p ( θ − {α}_{1} ) ] [ 1 + r cos ( φ − {α}_{1} ) ] + {R}_{4} + {L}_{4} \qquad ( 9 )$$

$$Formula 10$$

$${S}_{5} = {B}_{0} [ cos p ( θ − {α}_{5} ) + b cos 3 p ( θ − {α}_{5} ) ] [ 1 + r cos ( φ − {α}_{5} ) ] + {R}_{5} + {L}_{5} \qquad ( 10 )$$

$$Formula 11$$

$${S}_{6} = - {B}_{0} [ cos p ( θ − {α}_{3} ) + b cos 3 p ( θ − {α}_{3} ) ] [ 1 + r cos ( φ − {α}_{3} ) ] + {R}_{6} + {L}_{6} \qquad ( 11 )$$

Here, the computation unit 21 of the control unit 2 sets two magnetic sensors 17 as one pair, and computes a difference between signals of the pair of magnetic sensors 17. Specifically, the computation unit 21 sets the magnetic sensor 17-1 and the magnetic sensor 17-4 as a pair of sensors, the magnetic sensor 17-2 and the magnetic sensor 17-5 as a pair of sensors, and the magnetic sensor 17-3 and the magnetic sensor 17-6 as a pair of sensors.

S₁-S₄ is expressed by Formula (12) below, S₅-S₂ is expressed by Formula (13) below, and S₃-S₆ is expressed by Formula (14) below.

$$Formula 12$$

$${S}_{1} - {S}_{4} = 2 {B}_{0} [ cos p ( θ − {α}_{1} ) + b cos 3 p ( θ − {α}_{1} ) ] + {R}_{1} + {L}_{1} - {R}_{4} - {L}_{4} \qquad ( 12 )$$

$$Formula 13$$

$${S}_{5} - {S}_{2} = 2 {B}_{0} [ cos p ( θ − {α}_{5} ) + b cos 3 p ( θ − {α}_{5} ) ] - {R}_{2} + {L}_{2} + {R}_{5} + {L}_{5} = 2 {B}_{0} [ cos p ( θ − {α}_{1} ) - 120 ° ] + b cos 3 p ( θ - {α}_{1} ) ] - {R}_{2} - {L}_{2} + {R}_{5} + {L}_{5} \qquad ( 13 )$$

$$Formula 14$$

$${S}_{3} - {S}_{6} = 2 {B}_{0} [ cos p ( θ − {α}_{3} ) + b cos 3 p ( θ − {α}_{3} ) ] + {R}_{3} + {L}_{3} - {R}_{6} - {L}_{6} = 2 {B}_{0} [ cos p ( θ − {α}_{1} ) - 240 ° ] + b cos 3 p ( θ - {α}_{1} ) ] + {R}_{3} + {L}_{3} - {R}_{6} - {L}_{6} \qquad ( 14 )$$

Furthermore, the computation unit 21 performs three-to-two-phase conversion on the calculated “S₁-S₄”, “S₅-S₂”, and “S₃-S₆” as expressed by Formula (15).

$$Formula 15$$

$$\begin{matrix} & \sqrt{\frac{2}{3}} [ \begin{matrix}1 & - \frac{1}{2} & - \frac{1}{2} \\ 0 & \frac{\sqrt{3}}{2} & − \frac{\sqrt{3}}{2}\end{matrix} ] [ \begin{matrix}{S}_{1} - {S}_{4} \\ {S}_{5} - {S}_{2} \\ {S}_{3} - {S}_{6}\end{matrix} ] = \\ & \sqrt{\frac{2}{3}} [ \begin{matrix}\begin{matrix}3 {β}_{0} cos p ( θ − {α}_{1} ) + {R}_{1} + \\ L \text{?} − {R}_{4} − {L}_{4}\end{matrix} − \frac{\begin{matrix}- {R}_{2} − {L}_{2} + R \text{?} + L \text{?} + \\ R \text{?} + L \text{?} − {R}_{6} − {L}_{6}\end{matrix}}{2} \\ 3 {B}_{0} sin p ( θ − {α}_{1} ) + \frac{\sqrt{3}}{2} \begin{matrix}( − {R}_{2} − {L}_{2} + R \text{?} + L \text{?} − \\ {R}_{3} − {L}_{3} + {R}_{6} + {L}_{6} )\end{matrix}\end{matrix} ]\end{matrix} \qquad ( 15 )$$

$$\text{?} \text{indicates text missing or illegible when filed}$$

In Formula (15), even when the value of the coefficient b representing the ratio of the third-order harmonic component to the fundamental wave of the permanent magnet 11 is not zero, b is not included in the signal after the three-to-two-phase conversion. Therefore, the influence of the third-order harmonic component can be removed by taking the difference between the signals of the pair of magnetic sensors 17 and performing three-to-two-phase conversion.

In addition, a condition that the windings 16 located on both sides of the magnetic sensor 17 have the same phase and opposite directions of energization is considered. For example, the U-phase winding 16U and the U (bar) layer winding 16U (bar) are located on both sides of the magnetic sensor 17. Here, given that the current flowing through the winding 16U is represented by iᵤ and the proportional coefficient is represented by k, R₁=kiᵤ and L₁=−kiᵤ are satisfied. Therefore, R₁+L₁=0 holds. Similarly, since all the magnetic sensors 17 are provided in slots in which the windings 16 wound around the teeth 14 on both sides have the same phase and directions of energization opposite to each other, Rₙ+Lₙ=0 holds. At this time, Formula (16) below holds.

$$Formula 16$$

$$\sqrt{\frac{2}{3}} [ \begin{matrix}1 & − \frac{1}{2} & − \frac{1}{2} \\ 0 & \frac{\sqrt{3}}{2} & − \frac{\sqrt{3}}{2}\end{matrix} ] [ \begin{matrix}{S}_{1} - {S}_{4} \\ {S}_{5} - {S}_{2} \\ {S}_{3} - {S}_{6}\end{matrix} ] = \sqrt{\frac{2}{3}} [ \begin{matrix}3 {B}_{0} cos p ( θ − {α}_{1} ) \\ 3 {B}_{0} sin p ( θ − {α}_{1} )\end{matrix} ] \qquad ( 16 )$$

Therefore, the computation unit 21 substitutes the detected signal of the magnetic sensor 17 into Formula (16) to compute the arctangent, thereby obtaining p(θ-α₁). Here, if p and α₁ are known, the computation unit 21 can calculate θ.

That is, the influence of the spatial harmonic of a multiple of three from the permanent magnet 11 and the magnetic flux from the winding 16 is removed from the angle information output from the computation unit 21.

Next, a method of calculating the eccentricity will be described. Two magnetic sensors 17 are set as a pair, and the sum is computed. Specifically, the computation unit 21 sets the magnetic sensor 17-1 and the magnetic sensor 17-4 as a pair of sensors, the magnetic sensor 17-2 and the magnetic sensor 17-5 as a pair of sensors, and the magnetic sensor 17-3 and the magnetic sensor 17-6 as a pair of sensors.

S₁+S₄ is expressed by Formula (17) below, S₂+S₅ is expressed by Formula (18) below, and S₃+S₆ is expressed by Formula (19) below.

$$Formula 17$$

$${S}_{1} + {S}_{4} = 2 {B}_{0} [ cos p ( θ − {α}_{1} ) + b cos 3 p ( θ − {α}_{1} ) ] r cos ( φ − {α}_{1} ) + {R}_{1} + {L}_{1} + {R}_{4} + {L}_{4} \qquad ( 17 )$$

$$Formula 18$$

$${S}_{2} + {S}_{5} = 2 {B}_{0} [ cos p ( θ − α \text{?} ) + b cos 3 p ( θ − {α}_{5} ) ] r cos ( φ − {α}_{5} ) + {R}_{2} + {L}_{2} + {R}_{5} + {L}_{5} = 2 {B}_{0} [ cos [ p ( θ - {α}_{1} ) - 120 ° ] + b cos 3 p ( θ - {α}_{1} ) ] r cos ( φ - {α}_{1} + 120 ° ) + {R}_{2} + {L}_{2} + {R}_{5} + {L}_{5} \qquad ( 18 )$$

$$Formula 19$$

$${S}_{3} + {S}_{6} = 2 {B}_{0} [ cos p ( θ − {α}_{3} ) + b cos 3 p ( θ − {α}_{3} ) ] r cos ( φ − {α}_{3} ) + {R}_{3} + {L}_{3} + {R}_{6} + {L}_{6} = 2 {B}_{0} [ cos [ p ( θ - {α}_{1} ) - 240 ° ] + b cos 3 p ( θ - {α}_{1} ) ] r cos ( φ - {α}_{1} + 120 ° ) + {R}_{3} + {L}_{3} + {R}_{6} + {L}_{6} \qquad ( 19 )$$

$$\text{?} \text{indicates text missing or illegible when filed}$$

Furthermore, the computation unit 21 performs three-to-two-phase conversion on the calculated “S₁+S₄”, “S₂+S₅”, and “S₃+S₆” as expressed by Formula (20).

$$Formula 20$$

$$\sqrt{\frac{2}{3}} [ \begin{matrix}1 & − \frac{1}{2} & − \frac{1}{2} \\ 0 & \frac{\sqrt{3}}{2} & − \frac{\sqrt{3}}{2}\end{matrix} ] [ \begin{matrix}{S}_{1} + {S}_{4} \\ {S}_{2} + {S}_{5} \\ {S}_{3} + {S}_{6}\end{matrix} ] = \sqrt{\frac{2}{3}} [ \begin{matrix}\begin{matrix}3 {B}_{0} b cos 3 p ( θ − {α}_{1} ) r cos ( φ − {α}_{1} ) + \\ {R}_{1} + L \text{?} + {R}_{4} + {L}_{4}\end{matrix} - \frac{\begin{matrix}{R}_{2} + {L}_{2} + R \text{?} + L \text{?} + \\ {R}_{3} + {L}_{3} + {R}_{6} + {L}_{6}\end{matrix}}{2} \\ \begin{matrix}- 3 {B}_{0} b cos 3 p ( θ - {α}_{1} ) r sin ( φ - {α}_{1} ) + \frac{\sqrt{3}}{2} ( {R}_{2} + \\ {L}_{2} + R \text{?} + L \text{?} - {R}_{3} - {L}_{3} - {R}_{6} - {L}_{6} )\end{matrix}\end{matrix} ] + \sqrt{\frac{2}{3}} [ \begin{matrix}\begin{matrix}2 {B}_{0} r cos p ( θ − {α}_{1} ) cos ( φ − {α}_{1} ) + \\ sin p ( θ - {α}_{1} ) sin ( φ - {α}_{1} ) ) \frac{3}{4}\end{matrix} \\ \begin{matrix}2 {B}_{0} r cos p ( θ − {α}_{1} ) cos ( φ − {α}_{1} ) + \\ sin p ( θ - {α}_{1} ) sin ( φ - {α}_{1} ) ) \frac{3}{4}\end{matrix}\end{matrix} ] = \sqrt{\frac{2}{3}} [ \begin{matrix}\begin{matrix}3 {B}_{0} b cos 3 p ( θ − {α}_{1} ) r cos ( φ − {α}_{1} ) + \\ {R}_{1} + L \text{?} + {R}_{4} + {L}_{4}\end{matrix} - \frac{\begin{matrix}{R}_{2} + {L}_{2} + R \text{?} + L \text{?} + \\ {R}_{3} + {L}_{3} + {R}_{6} + {L}_{6}\end{matrix}}{2} \\ \begin{matrix}- 3 {B}_{0} b cos 3 p ( θ - {α}_{1} ) r sin ( φ - {α}_{1} ) + \frac{\sqrt{3}}{2} ( {R}_{2} + \\ {L}_{2} + R \text{?} + L \text{?} - {R}_{3} - {L}_{3} - {R}_{6} - {L}_{6} )\end{matrix}\end{matrix} ] + \sqrt{\frac{2}{3}} [ \begin{matrix}\frac{3}{2} {B}_{0} r cos [ p ( θ - {α}_{1} ) - ( φ - {α}_{1} ) ] \\ - \frac{3}{2} {B}_{0} r sin [ p ( θ - {α}_{1} ) - ( φ - {α}_{1} ) ]\end{matrix} ] \qquad ( 20 )$$

$$\text{?} \text{indicates text missing or illegible when filed}$$

As shown in Formula (20), the influence of the third-order harmonic component of the permanent magnet 11 remains for the eccentricity even after the three-to-two-phase conversion. However, if the magnetic sensor 17 is disposed inside the slot 15, as described above, the proportion of the third-order harmonic wave can be greatly reduced. Given that Rₙ+Lₙ=0 holds and the third-order harmonic is relatively negligibly small, Formula (20) can be approximated as Formula (21).

$$Formula 21$$

$$\sqrt{\frac{2}{3}} [ \begin{matrix}1 & - \frac{1}{2} & - \frac{1}{2} \\ 0 & \frac{\sqrt{3}}{2} & - \frac{\sqrt{3}}{2}\end{matrix} ] [ \begin{matrix}{S}_{1} + {S}_{4} \\ {S}_{2} + {S}_{5} \\ {S}_{3} + {S}_{6}\end{matrix} ] ≅ \sqrt{\frac{2}{3}} [ \begin{matrix}\frac{3}{2} {B}_{0} r cos [ p ( θ − {α}_{1} ) − ( φ − {α}_{1} ) ] \\ - \frac{3}{2} {B}_{0} r sin [ p ( θ - {α}_{1} ) - ( φ - {α}_{1} ) ]\end{matrix} ] = \sqrt{\frac{3}{2}} [ \begin{matrix}{B}_{0} r cos [ ( φ − {α}_{1} ) − p ( θ − {α}_{1} ) ] \\ {B}_{0} r sin [ ( φ − {α}_{1} ) − p ( θ − {α}_{1} ) ]\end{matrix} ] \qquad ( 21 )$$

Since B₀ cos p (θ-α₁) and B₀ sin p (θ-α₁) have been calculated, a function not including θ but including r and φ can be obtained by using these as a rotation matrix as indicated in Formula (22) below.

$$Formula 22$$

$$\frac{1}{{( {B}_{0} cos p ( θ − {a}_{1} ) )}^{2} + {( {B}_{0} sin p ( θ − {α}_{1} ) )}^{2}} [ \begin{matrix}{B}_{0} cos p ( θ − {α}_{1} ) & − {B}_{0} sin p ( θ − {α}_{1} ) \\ {B}_{0} sin p ( θ − {α}_{1} ) & {B}_{0} cos p ( θ − {α}_{1} )\end{matrix} ] \cdot [ \begin{matrix}{B}_{0} r cos [ ( φ − {α}_{1} ) − p ( θ − {α}_{1} ) ] \\ {B}_{0} r sin [ ( φ − {α}_{1} ) − p ( θ − {α}_{1} ) ]\end{matrix} ] = [ \begin{matrix}r cos ( φ − {α}_{1} ) \\ r sin ( φ − {α}_{1} )\end{matrix} ] \qquad ( 22 )$$

This is equivalent to the position information in the radial direction of the rotor 10. The computation unit 21 can calculate the eccentricity as described above.

Although the case where the number of pole pairs of the permanent magnet 11 is five, an odd number, has been described above, the rotation angle and the eccentricity can be similarly obtained even when the number of pole pairs is an even number. However, when the number of pole pairs is an even number, the sum is computed instead of the difference between the signals of the pair of magnetic sensors 17 in the calculation of the angle.

Although the motor 1 of 10 poles and 12 slots is described above, the number of slots only needs to be a multiple of six that is twelve or more, and the number p of pole pairs of the permanent magnet 11 and the number of pole pairs generated by the winding 16 only need to be larger than ⅓ times the number of slots and smaller than ⅔ times the number of slots. By setting the relationship among the number of slots, the number p of pole pairs of the permanent magnet 11, and the number of pole bodies generated by the winding 16 as described above, it is possible to provide the slots 15 in which the windings 16 wound around the teeth 14 on both sides have the same phase and directions of energization opposite to each other. Therefore, the signal of the magnetic sensor 17 used when the computation unit 21 obtains the rotation angle and/or the eccentricity of the motor 1 can be a signal of the magnetic sensor 17 provided in the slot 15 in which the windings 16 wound around the teeth 14 on both sides have the same phase and directions of energization opposite to each other.

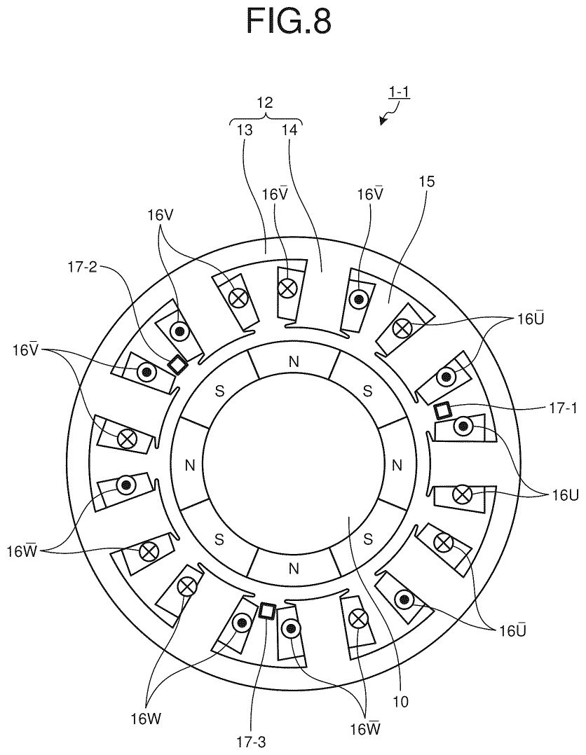

FIG. 8 is a diagram illustrating a cross-sectional configuration of a motor 1-1 according to a modification of the first embodiment. FIG. 8 illustrates the motor 1-1 having eight poles and nine slots. Differences from the motor 1 illustrated in FIG. 2 will be mainly described. The motor 1-1 is different from the motor 1 in that the motor 1 has 10 poles and 12 slots, whereas the motor 1-1 has 8 poles and 9 slots. That is, the motor 1-1 includes the rotor 10 and the stator 12. The stator 12 of the motor 1-1 has nine teeth 14, and the winding 16 is wound around each of the teeth 14. Here, the windings 16 of the motor 1-1 are, in order from the 3:00 direction on the paper of FIG. 8 to the counterclockwise direction, a winding 16U, a winding 16U (bar), a winding 16V (bar), a winding 16V, a winding 16V (bar), a winding 16W (bar), a winding 16W, a winding 16W (bar), and a winding 16U (bar). Here, the motor 1-1 includes magnetic sensors 17 disposed at three locations: the slot 15 provided between the winding 16U and the winding 16U (bar); the slot 15 provided between the winding 16V and the winding 16V (bar); and the slot 15 provided between the winding 16W and the winding 16W (bar).

Also in the motor 1-1, the magnetic sensor 17 is provided in the slot 15 in which the windings 16 wound around the teeth 14 on both sides have the same phase and directions of energization opposite to each other. The number p of pole pairs of the permanent magnet 11 is four, and the number p of pole pairs is larger than three, which is ⅓ times the number of slots nine, and smaller than six, which is ⅔ times the number of slots nine.

Although the example of eight poles and nine slots is shown here, the number of slots only needs to be a multiple of three that is nine or more, and the number p of pole pairs of the permanent magnet 11 and the number of pole pairs generated by the winding 16 only need to be larger than ⅓ times the number of slots and smaller than ⅔ times the number of slots. By setting the relationship among the number of slots, the number p of pole pairs of the permanent magnet 11, and the number of pole pairs generated by the winding 16 as described above, it is possible to provide the slots 15 in which the windings 16 wound around the teeth 14 on both sides have the same phase and directions of energization opposite to each other.

Although FIGS. 2 and 8 illustrate the radial gap motor in which the stator 12 is disposed outside the rotor 10 and the stator 12 and the rotor 10 face each other with a gap surface in the radial direction, the above-described effect can be obtained even in the case of an outer rotor type in which the stator 12 is disposed inside the rotor 10. Further, even in an axial gap motor in which the stator 12 and the rotor 10 face each other with a gap surface in the axial direction, a similar effect can be obtained.

The connection method of the U-phase, V-phase, and W-phase windings 16 may be Y connection or A connection. In addition, even when the windings 16 of the same phase are connected in series or in parallel, substantially the same magnitude of current flows in the same phase, so that a similar effect can be obtained. Although the motor 1 and the motor 1-1 using the three-phase windings 16 have been described in the first embodiment, even in a case where two-phase windings or windings of four or more phases are used, if the magnetic sensor 17 is disposed between windings having the same phase and directions of energization opposite to each other, an effect similar to that of the first embodiment can be obtained.

In addition, even in a case where a plurality of single-phase inverters and windings are used, a similar effect can be obtained by disposing a magnetic sensor between the single-phase windings.

As described above, according to the first embodiment, the motor system 100 including the motor 1 and the control unit 2 that controls the motor 1 is provided. The motor 1 includes the rotor 10 in which the permanent magnet 11 that is a magnetic flux generator that generates a magnetic flux is disposed, and the stator 12 disposed facing the rotor 10. The stator 12 includes the back yoke 13 disposed facing the rotor 10, and the plurality of teeth 14 protruding from the back yoke 13 toward the rotor 10 and disposed side by side at intervals in the rotation direction of the rotor 10. In addition, the motor 1 includes the winding 16 wound around the stator 12 and the plurality of magnetic sensors 17 provided in the slots 15, which are spaces between adjacent teeth 14, to measure a magnetic flux density. The control unit 2 includes the computation unit 21 that obtains the rotation angle and/or the eccentricity of the rotor 10 from signals of the plurality of magnetic sensors 17. The signal of the magnetic sensor 17 used by the computation unit 21 is a signal of the magnetic sensor 17 provided in the slot 15 in which the windings 16 on both sides have the same phase and directions of energization opposite to each other. By providing the magnetic sensor 17 in the slot 15 in which the windings 16 on both sides have the same phase and directions of energization opposite to each other, the signal of the magnetic sensor 17 is that in which the influence from one winding 16 of the windings 16 on both sides is cancelled by the influence from the other winding 16 even when the winding 16 is energized. Therefore, it is possible to reduce the detection error of information of a detection target that is the rotation angle and/or the eccentricity.

Furthermore, the magnetic sensor 17 is disposed inside the slot 15, that is, between the adjacent teeth 14, and closer to the back yoke 13 in the radial R direction around the rotation axis of the motor 1 than the tip of the teeth 14. As a result, the spatial harmonic component can be greatly reduced from the signal of the magnetic sensor 17, and the detection error of information of a detection target that is the rotation angle and/or the eccentricity can be reduced. In the axial motor, “closer to the back yoke 13” means the axial direction, that is, the Z direction.

In addition, the motor 1 includes three pairs of magnetic sensors 17 each including a first sensor and a second sensor, and the computation unit 21 computes the sum of or the difference between a signal of the first sensor and a signal of the second sensor in each pair. As a result, the influence of the spatial harmonic component of a multiple of three from the permanent magnet 11 and the influence of the magnetic flux generated by energization to the winding 16 are removed from the rotation angle and the eccentricity output from the computation unit 21. Therefore, it is possible to reduce the detection error of information of a detection target that is the rotation angle and/or the eccentricity.

The number of slots 15 in the motor 1 is “12”, which satisfies the condition of a multiple of six that is twelve or more. The motor 1 satisfies the condition that the number of pole pairs of the permanent magnet 11 as a magnetic flux generator and the number of pole pairs generated by the winding 16 are “5”, which is larger than “4” that is ⅓ times the number of slots “12” and smaller than “8” that is ⅔ times the number of slots “12”. By setting the number of slots and the number of pole pairs so as to satisfy such conditions, the magnetic sensor 17 can be disposed in the slots 15 in which the windings 16 wound around the teeth 14 on both sides have the same phase and directions of energization opposite to each other. Therefore, it is possible to reduce the detection error of information of a detection target that is the rotation angle and/or the eccentricity.

The motor 1-1 according to the modification of the first embodiment has eight poles and nine slots. In this case, the number of slots is “9”, which satisfies the condition of a multiple of three that is nine or more. The condition is satisfied that the number of pole pairs of the permanent magnet 11 and the number of pole pairs generated by the winding 16 are “4”, which is larger than “3” that is ⅓ times the number of slots “9” and smaller than “6” that is ⅔ times the number of slots “9”. By setting the number of slots and the number of pole pairs so as to satisfy such conditions, the magnetic sensor 17 can be disposed in the slots 15 in which the windings 16 wound around the teeth 14 on both sides have the same phase and directions of energization opposite to each other. Therefore, it is possible to reduce the detection error of information of a detection target that is the rotation angle and/or the eccentricity.

### Second Embodiment

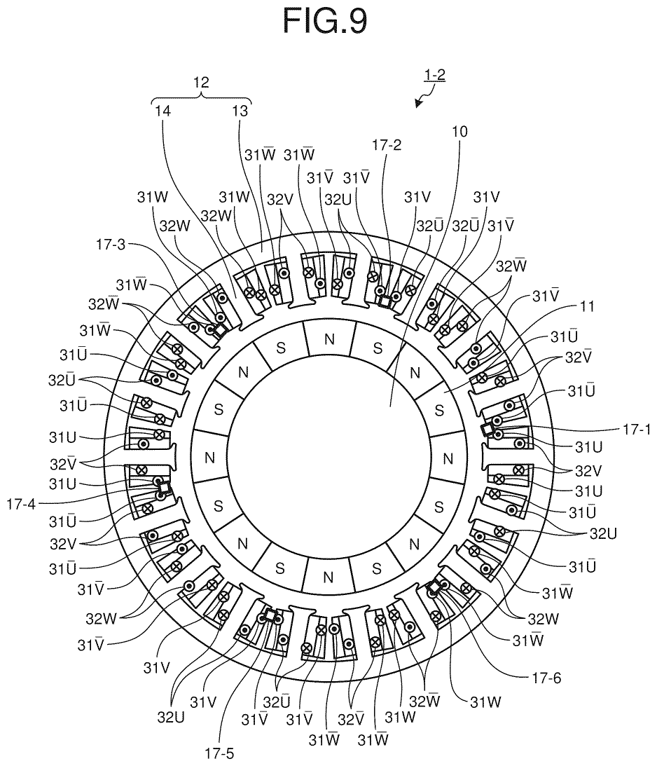

FIG. 9 is a diagram illustrating a cross-sectional configuration of a motor 1-2 according to the second embodiment. The motor 1-2 is different from that of the first embodiment in that it has 16 poles and 18 slots and two types of windings are wound around each tooth 14. The configuration of the motor 1-2 is similar to that of the motor 1 except for the above points. The motor 1-2 includes the rotor 10 having the back yoke 13 and the teeth 14, the rotor 10 including the permanent magnet 11, and the magnetic sensor 17 provided in a space between adjacent teeth 14. Note that the signal of the magnetic sensor 17 is output to the computation unit 21 of the control unit 2 as in the first embodiment. Hereinafter, differences from the first embodiment will be mainly described.

The motor 1-2 has 18 teeth 14. A first winding 31 and a second winding 32 are wound around each tooth 14. In the example of FIG. 9, the first winding 31 and the second winding 32 are wound in an overlapping manner. Here, the first winding 31 is wound outside the second winding 32. The rotor 10 includes the 16-pole permanent magnet 11. The number of slots 15 of the stator 12 is 18.

The first winding 31 is wound around the 18 teeth 14 so as to generate a magnetic field of 16 poles. The first windings 31 of the motor 1-2 are, in order from the 3:00 direction on the paper of FIG. 9 to the counterclockwise direction, a first winding 310, a first winding 31U (bar), a first winding 31V (bar), a first winding 31V, a first winding 31V (bar), a first winding 31W (bar), a first winding 31W, a first winding 31W (bar), a first winding 31U (bar), a first winding 31U, a first winding 31U (bar), a first winding 31V (bar), a first winding 31V, a first winding 31V (bar), a first winding 31W (bar), a first winding 31W, a first winding 31W (bar), and a first winding 310 (bar). The second winding 32 of the motor 1-2 is wound around the 18 teeth 14 so as to generate a magnetic field of 14 poles. The second windings 32 are, in order from the 3:00 direction on the paper of FIG. 9 to the counterclockwise direction, a second winding 32V, a second winding 32V (bar), a second winding 32W (bar), a second winding 32U (bar), a second winding 320, a second winding 32V, a second winding 32W, a second winding 32W (bar), a second winding 320 (bar), a second winding 32V (bar), a second winding 32V, a second winding 32W, a second winding 32U, a second winding 32U (bar), a second winding 32V (bar), a second winding 32W (bar), a second winding 32W, and a second winding 32U.

The number of pole pairs generated by the second winding 32 is seven, and the number p of pole pairs of the permanent magnet 11 is eight. At this time, the condition that the number of pole pairs generated by the second winding 32 is larger by one or smaller by one than the number of pole pairs of the permanent magnet 11 is satisfied. The number of pole pairs generated by the second winding 32 is larger than six, which is ⅓ times the number of slots, and smaller than 12, which is ⅔ times the number of slots.

The motor 1-2 includes the six magnetic sensors 17-1 to 17-6. The magnetic sensor 17-1 is disposed between the first winding 31U and the first winding 31U (bar). The magnetic sensor 17-2 is disposed between the first winding 31V and the first winding 31V (bar). The magnetic sensor 17-3 is disposed between the first winding 31W and the first winding 31W (bar). The magnetic sensor 17-4 is disposed between the first winding 31U and the first winding 31U (bar). The magnetic sensor 17-5 is disposed between the first winding 31V and the first winding 31V (bar). The magnetic sensor 17-6 is disposed between the first winding 31W and the first winding 31W (bar).

The magnetic sensor 17-1 is disposed between the second winding 32V and the second winding 32V (bar). The magnetic sensor 17-2 is disposed between the second winding 32U and the second winding 32U (bar). The magnetic sensor 17-3 is disposed between the second winding 32W and the second winding 32W (bar). The magnetic sensor 17-4 is disposed between the second winding 320 and the second winding 32U (bar). The magnetic sensor 17-5 is disposed between the second winding 32U and the second winding 32U (bar). The magnetic sensor 17-6 is disposed between the second winding 32W and the second winding 32W (bar).

In the motor 1-2, each of the magnetic sensors 17-1 to 17-6 is provided in the slot 15 in which the first windings 31 wound around the teeth 14 on both sides have the same phase and directions of energization opposite to each other, and the second windings 32 wound around the teeth 14 on both sides have the same phase and directions of energization opposite to each other. Therefore, similarly to the first embodiment, it is possible to simultaneously reduce the influence of the magnetic flux of the first winding 31 and the influence of the magnetic flux of the second winding 32.

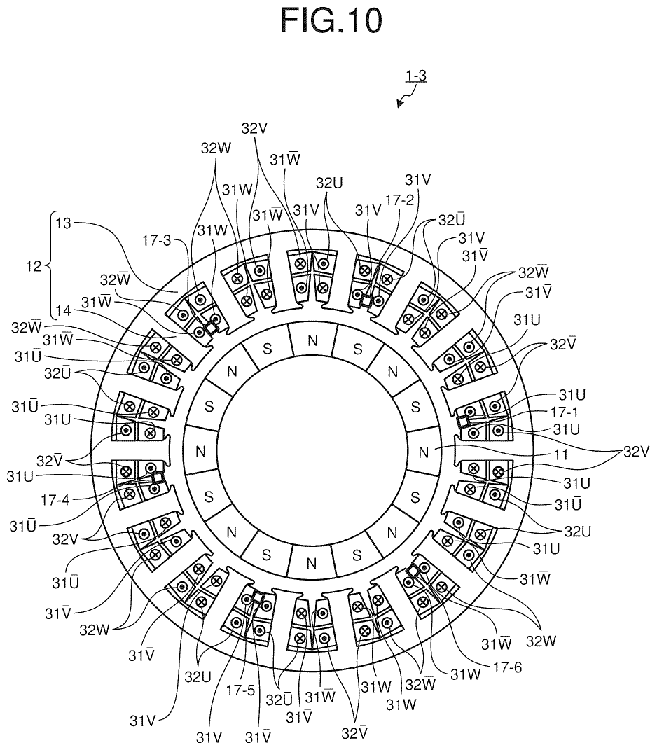

FIG. 10 is a diagram illustrating a cross-sectional configuration of a motor 1-3 according to a modification of the second embodiment. Here, differences from the motor 1-2 will be mainly described. The first winding 31 of the motor 1-3 is wound inside the second winding 32 in the radial R direction around the rotation axis of the motor 1-3. Even when the first winding 31 and the second winding 32 are wound as described above, an effect similar to that of the motor 1-2 can be obtained.

If the second windings 32 are, in order from the 3:00 direction on the paper of FIG. 9 to the counterclockwise direction, a second winding 32U, a second winding 32V, a second winding 32V (bar), a second winding 32W (bar), a second winding 32U (bar), a second winding 32U, a second winding 32V, a second winding 32W, a second winding 32W (bar), a second winding 32U (bar), a second winding 32V (bar), a second winding 32V, a second winding 32W, a second winding 32U, a second winding 32U (bar), a second winding 32V (bar), a second winding 32W (bar), and a second winding 32W, the above effect cannot be obtained. The arrangement of the second windings 32 needs to be devised in consideration of the relationship with the first windings 31 such that the first windings 31 wound around the teeth 14 on both sides have the same phase and directions of energization opposite to each other, and the second windings 32 wound around the teeth 14 on both sides of the slot 15 have the same phase and directions of energization opposite to each other.

As described above, according to the second embodiment, the motor system 100 including the motor 1-2 instead of the motor 1 in FIG. 1 is provided. Although the motor system 100 including the motor 1-2 will be described below, the same applies to the motor system 100 including the motor 1-3 instead of the motor 1-2. The motor 1-2 includes the rotor 10 in which the permanent magnet 11 that is a magnetic flux generator that generates a magnetic flux is disposed, and the stator 12 disposed facing the rotor 10. The stator 12 includes the back yoke 13 disposed facing the rotor 10, and the plurality of teeth 14 protruding from the back yoke 13 toward the rotor 10 and disposed side by side at intervals in the rotation direction of the rotor 10. In addition, the motor 1 includes the first winding 31 wound around the stator 12 and the plurality of magnetic sensors 17 provided in the slots 15, which are spaces between adjacent teeth 14, to measure a magnetic flux density. The control unit 2 includes the computation unit 21 that obtains the rotation angle and/or the eccentricity of the rotor 10 from signals of the plurality of magnetic sensors 17. The signal of the magnetic sensor 17 used by the computation unit 21 is a signal of the magnetic sensor 17 provided in the slot 15 in which the first windings 31 on both sides have the same phase and directions of energization opposite to each other. By providing the magnetic sensor 17 in the slot 15 in which the first windings 31 on both sides have the same phase and directions of energization opposite to each other, the signal of the magnetic sensor 17 is that in which the influence from one first winding 31 of the first windings 31 on both sides is cancelled by the influence from the other first winding 31 even when the first winding 31 is energized. Therefore, it is possible to reduce the detection error of information of a detection target that is the rotation angle and/or the eccentricity.

Also in the second embodiment, the magnetic sensor 17 is disposed inside the slot 15, that is, between the adjacent teeth 14, and closer to the back yoke 13 in the radial R direction around the rotation axis of the motor 1 than the tip of the teeth 14. As a result, the spatial harmonic component can be greatly reduced from the signal of the magnetic sensor 17, and the detection error of information of a detection target that is the rotation angle and/or the eccentricity can be reduced.

In addition, the motor 1-2 includes three pairs of magnetic sensors 17 each including a first sensor and a second sensor, and the computation unit 21 computes the sum of or the difference between a signal of the first sensor and a signal of the second sensor in each pair. As a result, the influence of the spatial harmonic component of a multiple of three from the permanent magnet 11 and the influence of the magnetic flux generated by energization to the first winding 31 are removed from the rotation angle and the eccentricity output from the computation unit 21. Therefore, it is possible to reduce the detection error of information of a detection target that is the rotation angle and/or the eccentricity.

The number of slots 15 in the motor 1-2 is “18”, which satisfies the condition of a multiple of six that is twelve or more. The motor 1-2 satisfies the condition that the number of pole pairs of the permanent magnet 11 as a magnetic flux generator and the number of pole pairs generated by the winding 16 are “8”, which is larger than “6” that is ⅓ times the number of slots “18” and smaller than “12” that is ⅔ times the number of slots “18”. By setting the number of slots and the number of pole pairs so as to satisfy such conditions, the magnetic sensor 17 can be disposed in the slots 15 in which the first windings 31 on both sides have the same phase and directions of energization opposite to each other. Therefore, it is possible to reduce the detection error of information of a detection target that is the rotation angle and/or the eccentricity.

According to the second embodiment, the motor 1-2 further includes the second winding 32 wound around the stator 12. The condition is satisfied that the number of pole pairs “7” generated by the second winding 32 is larger by one than the number of pole pairs “8” of the permanent magnet 11 that is the magnetic flux generator, or smaller by one than the number of pole pairs “8” of the permanent magnet 11. The condition is satisfied that the number of pole pairs “7” generated by the second winding 32 is larger than “6”, which is ⅓ times the number of slots “18”, and smaller than “12”, which is ⅔ times the number of slots “18”. By setting the number of slots and the number of pole pairs so as to satisfy such conditions, the magnetic sensor 17 can be disposed in the slots 15 in which the second windings 32 on both sides have the same phase and directions of energization opposite to each other. Therefore, it is possible to reduce the detection error of information of a detection target that is the rotation angle and/or the eccentricity.

### Third Embodiment

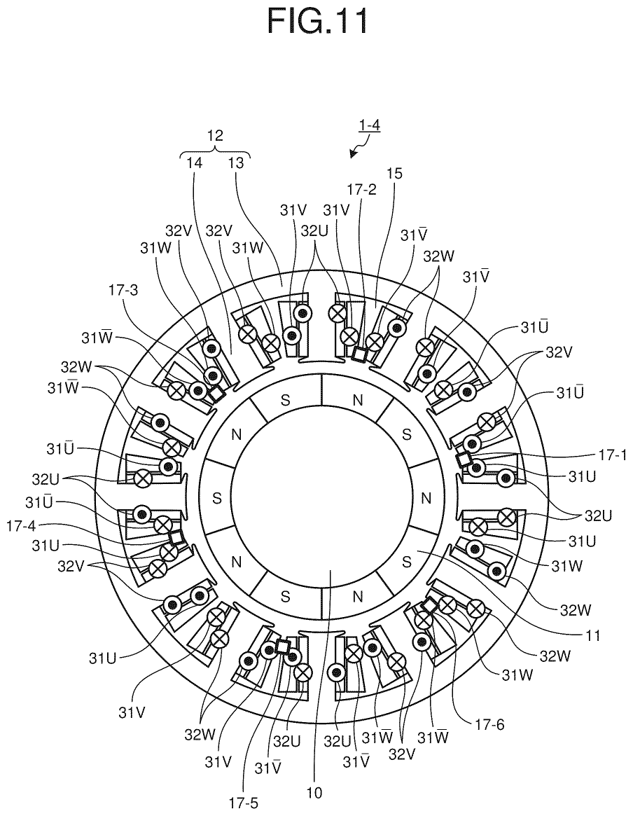

FIG. 11 is a diagram illustrating a cross-sectional configuration of a motor 1-4 according to the third embodiment. Like the motor 1-2 according to the second embodiment, the motor 1-4 includes two types of windings, the first winding 31 and the second winding 32. In the motor 1-2, both the first winding 31 and the second winding 32 wound around the teeth 14 on both sides of the slot 15 in which the magnetic sensor 17 is disposed are characterized in having the same phase and directions of energization opposite to each other. On the other hand, in the motor 1-4, the first windings 31 wound around the teeth 14 on both sides of the slot 15 in which the magnetic sensor 17 is disposed are characterized in having the same phase and directions of energization opposite to each other, whereas the second windings 32 wound around the teeth 14 on both sides of the slot 15 in which the magnetic sensor 17 is disposed have different phases. Note that the signal of the magnetic sensor 17 is output to the computation unit 21 of the control unit 2 as in the first embodiment. Below is a detailed description thereof.

The motor 1-4 includes the rotor 10, the permanent magnet 11 disposed in the rotor 10, the stator 12 having the back yoke 13 and the teeth 14, and the magnetic sensor 17 disposed in the slot 15 that is a space between adjacent teeth 14. The first winding 31 and the second winding 32 are wound around the teeth 14. The first winding 31 and the second winding 32 are wound in an overlapping manner; here, the first winding 31 is wound outside the second winding 32. The rotor 10 includes the 10-pole permanent magnet 11. The number of slots 15 of the stator 12 is 12.

The first winding 31 is wound around the 12 teeth 14 so as to generate a magnetic field of 10 poles. The second winding 32 is wound around the 12 teeth 14 so as to generate a magnetic field of 8 poles. The first windings 31 are, in order from the 3:00 direction on the paper of FIG. 11 to the counterclockwise direction, a first winding 31U, a first winding 31U (bar), a first winding 31V (bar), a first winding 31V, a first winding 31W, a first winding 31W (bar), a first winding 31U (bar), a first winding 31U, a first winding 31V, a first winding 31V (bar), a first winding 31W (bar), and a first winding 31W. The second windings 32 are, in order from the 3:00 direction on the paper of FIG. 11 to the counterclockwise direction, a second winding 320, a second winding 32V, a second winding 32W, a second winding 320, a second winding 32V, a second winding 32W, a second winding 32U, a second winding 32V, and a second winding 32W.

The number of pole pairs generated by the second winding 32 is four, and the number of pole pairs of the permanent magnet 11 is five. At this time, the condition that the number of pole pairs generated by the second winding 32 is larger by one or smaller by one than the number of pole pairs of the permanent magnet 11 is satisfied.

The motor 1-4 includes the six magnetic sensors 17-1 to 17-6. The magnetic sensor 17-1 is disposed between the first winding 31U and the first winding 310 (bar). The magnetic sensor 17-2 is disposed between the first winding 31V and the first winding 31V (bar). The magnetic sensor 17-3 is disposed between the first winding 31W and the first winding 31W (bar). The magnetic sensor 17-4 is disposed between the first winding 31U and the first winding 31U (bar). The magnetic sensor 17-5 is disposed between the first winding 31V and the first winding 31V (bar). The magnetic sensor 17-6 is disposed between the first winding 31W and the first winding 31W (bar).

The magnetic sensor 17-1 is disposed between the second winding 320 and the second winding 32V. The magnetic sensor 17-2 is disposed between the second winding 32W and the second winding 32U. The magnetic sensor 17-3 is disposed between the second winding 32V and the second winding 32W. The magnetic sensor 17-4 is disposed between the second winding 32U and the second winding 32V. The magnetic sensor 17-5 is disposed between the second winding 32W and the second winding 32U. The magnetic sensor 17-6 is disposed between the second winding 32V and the second winding 32W.

Here, the first windings 31 located on both sides of the magnetic sensor 17 satisfy the condition of having the same phase and directions of energization opposite to each other, but the second windings 32 located on both sides of the magnetic sensor 17 have different phases. Therefore, when viewed alone, the signal of the magnetic sensor 17 is affected by the energization of the second winding 32. Therefore, the computation unit 21 of the control unit 2 treats two magnetic sensors 17 as a pair, and computes the difference between the two signals of the pair of magnetic sensors 17 to cancel the influence of the second winding 32. Here, two magnetic sensors 17 having the same combination of phases of the second windings 32 located on both sides of the magnetic sensor 17 are treated as a pair of magnetic sensors 17.

For example, the magnetic sensor 17-1 and the magnetic sensor 17-4 are both disposed between the second winding 32U and the second winding 32V. Here, the influence of the second winding 32 on the magnetic sensor 17-1 is expressed as kiᵤ+kiᵥ, where k is a coefficient, iᵤ is a U-phase current, and iᵥ is a V-phase current. Similarly, the influence of the second winding 32 on the magnetic sensor 17-4 is also expressed as kiᵤ+kiᵥ. Therefore, if the magnetic sensor 17-1 and the magnetic sensor 17-4 are treated as a pair and the difference between the signal of the magnetic sensor 17-1 and the signal of the magnetic sensor 17-4 is computed, the influences of the second windings 32 are canceled, and only the magnetic flux component of the permanent magnet 11 of the rotor 10 can be extracted.

Similarly, the magnetic sensor 17-2 and the magnetic sensor 17-5 are both disposed between the second winding 32W and the second winding 320. The magnetic sensor 17-3 and the magnetic sensor 17-6 are both disposed between the second winding 32V and the second winding 32W. Therefore, by treating the magnetic sensor 17-2 and the magnetic sensor 17-5 as a pair and treating the magnetic sensor 17-3 and the magnetic sensor 17-6 as a pair, it is possible to cancel the influence of the second winding 32.

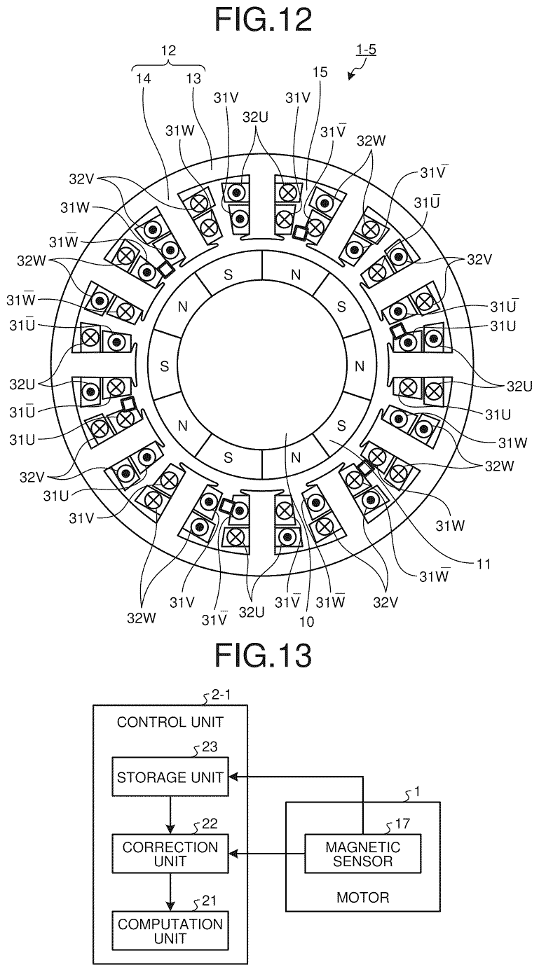

FIG. 12 is a diagram illustrating a cross-sectional configuration of a motor 1-5 according to a modification of the third embodiment. The configuration of the motor 1-5 is similar to that of the motor 1-4 except that method of winding the first winding 31 and the second winding 32 around the teeth 14 is different from that for the motor 1-4. The first winding 31 of the motor 1-5 is wound inside the second winding 32 in the radial R direction around the rotation axis of the motor 1-5. Even when the first winding 31 and the second winding 32 are wound as described above, by treating two magnetic sensors 17 as a pair, an effect similar to that of the motor 1-4 can be obtained.

As described above, according to the third embodiment, the motor system 100 including the motor 1-4 instead of the motor 1 in FIG. 1 is provided. Although the motor system 100 including the motor 1-4 will be described below, the same applies to the motor system 100 including the motor 1-5 instead of the motor 1-4. The motor 1-4 includes the rotor 10 in which the permanent magnet 11 that is a magnetic flux generator that generates a magnetic flux is disposed, and the stator 12 disposed facing the rotor 10. The stator 12 includes the back yoke 13 disposed facing the rotor 10, and the plurality of teeth 14 protruding from the back yoke 13 toward the rotor 10 and disposed side by side at intervals in the rotation direction of the rotor 10. In addition, the motor 1 includes the first winding 31 wound around the stator 12 and the plurality of magnetic sensors 17 provided in the slots 15, which are spaces between adjacent teeth 14, to measure a magnetic flux density. The control unit 2 includes the computation unit 21 that obtains the rotation angle and/or the eccentricity of the rotor 10 from signals of the plurality of magnetic sensors 17. The signal of the magnetic sensor 17 used by the computation unit 21 is a signal of the magnetic sensor 17 provided in the slot 15 in which the first windings 31 on both sides have the same phase and directions of energization opposite to each other. By providing the magnetic sensor 17 in the slot 15 in which the first windings 31 on both sides have the same phase and directions of energization opposite to each other, the signal of the magnetic sensor 17 is that in which the influence from one first winding 31 of the first windings 31 on both sides is cancelled by the influence from the other first winding 31 even when the first winding 31 is energized. Therefore, it is possible to reduce the detection error of information of a detection target that is the rotation angle and/or the eccentricity.

Also in the third embodiment, the magnetic sensor 17 is disposed inside the slot 15, that is, between the adjacent teeth 14, and closer to the back yoke 13 in the radial R direction around the rotation axis of the motor 1 than the tip of the teeth 14. As a result, the spatial harmonic component can be greatly reduced from the signal of the magnetic sensor 17, and the detection error of information of a detection target that is the rotation angle and/or the eccentricity can be reduced.

In addition, the motor 1-4 includes three pairs of magnetic sensors 17 each including a first sensor and a second sensor, and the computation unit 21 computes the sum of or the difference between a signal of the first sensor and a signal of the second sensor in each pair. As a result, the influence of the spatial harmonic component of a multiple of three from the permanent magnet 11 and the influence of the magnetic flux generated by energization to the first winding 31 are removed from the rotation angle and the eccentricity output from the computation unit 21. Therefore, it is possible to reduce the detection error of information of a detection target that is the rotation angle and/or the eccentricity.

The number of slots 15 in the motor 1-4 is “12”, which satisfies the condition of a multiple of six that is twelve or more. The motor 1-4 satisfies the condition that the number of pole pairs of the permanent magnet 11 as a magnetic flux generator and the number of pole pairs generated by the winding 16 are “5”, which is larger than “4” that is ⅓ times the number of slots “12” and smaller than “8” that is ⅔ times the number of slots “12”. By setting the number of slots and the number of pole pairs so as to satisfy such conditions, the magnetic sensor 17 can be disposed in the slots 15 in which the first windings 31 on both sides have the same phase and directions of energization opposite to each other. Therefore, it is possible to reduce the detection error of information of a detection target that is the rotation angle and/or the eccentricity.

According to the second embodiment, the motor 1-4 further includes the second winding 32 wound around the teeth 14. The condition is satisfied that the number of pole pairs “4” generated by the second winding 32 is larger by one than the number of pole pairs “5” of the permanent magnet 11 that is the magnetic flux generator, or smaller by one than the number of pole pairs “5” of the permanent magnet 11. In addition, the phases of the second windings 32 on both sides of the slot 15 in which the magnetic sensor 17 is provided are different from each other. The computation unit 21 can cancel the influence of the magnetic flux from the second winding 32 from the signal 17 of the magnetic sensor 17 by computing the sum or difference between the signal of the first sensor, which is one of the plurality of magnetic sensors 17 included in the motor 1-4, and the signal of the second sensor disposed between the second windings 32 of the same combination of phases as the combination of the phases of the second windings 32 on both sides of the slot 15 in which the first sensor is provided. Therefore, it is possible to reduce the detection error of information of a detection target that is the rotation angle and/or the eccentricity.

### Fourth Embodiment

FIG. 13 is a diagram illustrating a configuration of a control unit 2-1 according to the fourth embodiment. The control unit 2-1 includes the computation unit 21, a correction unit 22, and a storage unit 23. Here, the signal of the magnetic sensor 17 disposed in the motor 1 is input to the control unit 2-1, but the signal input to the control unit 2-1 may be a signal of the magnetic sensor 17 disposed in any one of the motors 1-1 to 1-5.

The correction unit 22 has a function of correcting an influence on the signal of the magnetic sensor 17 due to a change in the energization amount to the windings 16 located on both sides of the magnetic sensor 17.

The storage unit 23 stores the change amount of the signal of the magnetic sensor 17 corresponding to the energization amount. This change amount is calculated from the signal of the magnetic sensor 17 actually detected when the energization amount to the winding 16 is changed.

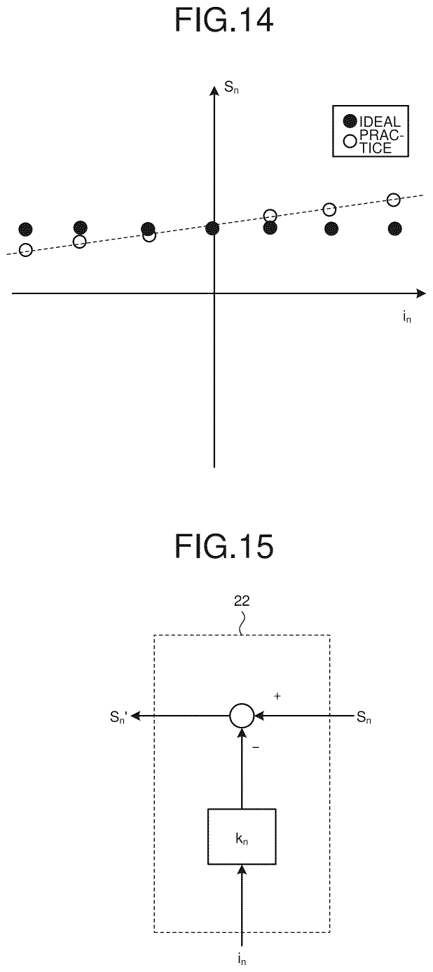

FIG. 14 is a diagram illustrating an example of a relationship between the energization amount to the winding 16 and the signal of the magnetic sensor 17. The horizontal axis of FIG. 14 is the current iₙ flowing through the winding 16. Here, n of the current iₙ may be any of the U, V, and W phases which are phases of the windings 16 disposed on both sides of the magnetic sensor 17, or may be a value obtained by performing four arithmetic operations on a plurality of three-phase currents. In FIG. 14, the vertical axis represents the signal Sₙ of the magnetic sensor 17. Here, n of the signal Sₙ may be a sensor number or a value obtained by performing four arithmetic operations on the signals of the plurality of magnetic sensors 17. The intercept on the vertical axis means a term contributed by the rotor 10. This value changes as the rotor 10 rotates.

Ideally, even when the energization amount to the windings 16 located on both sides of the magnetic sensor 17 changes, the influence of the windings 16 on both sides of the magnetic sensor 17 is canceled by the influence from one winding 16 and the influence from the other winding 16, and the signal of the magnetic sensor 17 is constant regardless of the value of the current iₙ. However, in practice, the influence of the current iₙ remains slightly without being canceled because of asymmetry due to a difference in the winding bulge of the windings 16 located on both sides of the magnetic sensor 17, misalignment of the magnetic sensor 17, and the like. Therefore, as illustrated in FIG. 14, the signal of the magnetic sensor 17 may change depending on the energization amount. As described above, this relationship is caused by asymmetry of the winding 16, misalignment of the magnetic sensor 17, and the like, and thus differs between the motors 1. By disposing the magnetic sensor 17 in the slot 15 in which the windings 16 located on both sides have the same phase and directions of energization opposite to each other, the influence of the energization to the winding 16 on the magnetic sensor 17 can be greatly reduced, but the influence of the energization caused by the asymmetry of the winding 16, the misalignment of the magnetic sensor 17, and the like as described above slightly remains. The correction unit 22 corrects the influence of energization due to asymmetry of the winding 16, misalignment of the magnetic sensor 17, and the like by post-processing.

FIG. 15 is a diagram for explaining the correction unit 22 illustrated in FIG. 13. The correction unit 22 corrects the signal Sₙ of the magnetic sensor 17 and outputs a corrected signal Sₙ′. For example, assuming that linearity is established between the current iₙ and the signal Sₙ of the magnetic sensor 17 from the relationship between the current iₙ and the signal Sₙ as illustrated in FIG. 14, a relationship of Sₙ=Sₙ′+kₙiₙ is established. Here, Sₙ′ is a term contributed by the rotor 10 in the signal Sₙ output from the magnetic sensor 17, and corresponds to the intercept in FIG. 14. In addition, kₙiₙ is a term contributed by the current iₙ of the stator 12. In FIG. 14, the coefficient kₙ corresponds to the slope. The coefficient kₙ may be, for example, Rₙ+Lₙ described above. Ideally, the coefficient kₙ=0.

From the actual measurement result as illustrated in FIG. 14, the correction unit 22 can obtain the coefficient kₙ by using, for example, the least squares method. The coefficient kₙ can also be obtained by simply computing (Sₙ₁-Sₙ₂)/(iₙ₁-iₙ₂) only from the results (Sₙ₁, iₙ₁) and (Sₙ₂, iₙ₂) actually measured under two conditions.

After obtaining the coefficient kₙ, the correction unit 22 can correct the signal of the magnetic sensor 17 by computing “Sₙ′=Sₙ-kₙiₙ”. Therefore, the correction unit 22 can calculate the corrected signal Sₙ′ from the signal Sₙ of the magnetic sensor 17 on the basis of the information indicating the relationship between the energization amount and the change amount of the signal of the magnetic sensor 17 stored in the storage unit 23, and output the corrected signal Sₙ′ to the computation unit 21.

In the above description, as illustrated in FIG. 14, the relationship between the current iₙ and the signal Sₙ of the magnetic sensor 17 has been described as being represented by a linear function, but other than the linear function, a quadratic function or the like may be used. In addition, even without the correction unit 22, an effect similar to that of the first embodiment can be obtained, and thus the correction unit 22 may be omitted.

As described above, the control unit 2-1 according to the fourth embodiment includes the storage unit 23 that stores the relationship between the energization amount and the change amount of the signal of the magnetic sensor 17 obtained from the signal of the magnetic sensor 17 acquired when the energization amount of the winding 16 is changed, and the correction unit 22 that corrects the signal of the magnetic sensor 17 based on the relationship between the energization amount and the change amount of the signal of the magnetic sensor 17 stored in the storage unit 23. Here, the information indicating the relationship between the energization amount and the change amount of the signal of the magnetic sensor 17 may be, for example, the coefficient kₙ or the change amount of the signal of the magnetic sensor 17 corresponding to each energization amount. With such a configuration, even when the signal of the magnetic sensor 17 changes due to a change in the energization amount to the winding 16, it is possible to reduce the detection error of information of a detection target that is at least the rotation angle and/or the eccentricity amount by correcting the signal of the magnetic sensor 17.

Note that each of the control unit 2 illustrated in FIG. 1 and the control unit 2-1 illustrated in FIG. 13 is implemented by processing circuitry. The processing circuitry may be dedicated hardware or may be a control circuit using a central processing unit (CPU). The dedicated hardware for implementing the control units 2 and 2-1 is, for example, a single circuit, a composite circuit, a programmed processor, a parallel programmed processor, an application specific integrated circuit (ASIC), a field programmable gate array (FPGA), or a combination thereof.

When the above processing circuitry is implemented by a control circuit using a CPU, the control circuit can include a processor and a memory. The processor is a CPU, and is also called a processing device, an arithmetic device, a microprocessor, a microcomputer, a digital signal processor (DSP), or the like. Examples of the memory include a non-volatile or volatile semiconductor memory, a magnetic disk, a flexible disk, an optical disc, a compact disc, a mini disc, a digital versatile disc (DVD), and the like. Examples of non-volatile or volatile semiconductor memories include a random access memory (RAM), a read only memory (ROM), a flash memory, an erasable programmable ROM (EPROM), an electrically EPROM (EEPROM, registered trademark), and the like.

In a case where the above processing circuitry is implemented by the control circuit, the processor reads and executes the program corresponding to the process of each component stored in the memory, thereby implementing the processing circuitry. The memory is also used as a temporary memory for each process executed by the processor.

The configurations described in the above-mentioned embodiments indicate examples. The embodiments can be combined with another well-known technique and with each other, and some of the configurations can be omitted or changed in a range not departing from the gist.

For example, the winding 16, the first winding 31, and the second winding 32 are wound around the teeth 14 in the above embodiments, but only need to be wound around the stator 12, for example, may be wound around the back yoke 13. Even in the case of being wound around the back yoke 13, the winding 16, the first winding 31, and the second winding 32 are wound around both sides of each tooth 14 in the circumferential direction in which the teeth 14 are arranged, for example, so as to be located on both sides of the slot 15.

### REFERENCE SIGNS LIST

1, 1-1 to 1-5 motor; 2, 2-1 control unit; 10 rotor; 11 permanent magnet; 12 stator; 13 back yoke; 14 teeth; 15 slot; 16 winding; 17, 17-1 to 17-6 magnetic sensor; 18U, 19 magnetic flux; 21 computation unit; 32 correction unit; 23 storage unit; 31 first winding; 32 second winding; 100 motor system.

1.-claim 11. (canceled)

12. A motor comprising:
a rotor in which a magnetic flux generator that generates a magnetic flux is disposed;
a stator including a back yoke disposed facing the rotor, and a plurality of teeth protruding from the back yoke toward the rotor and disposed at intervals in a circumferential direction;
a winding wound around the stator; and
a plurality of magnetic sensors provided in slots that are spaces between adjacent ones of the teeth, wherein
the winding includes a first winding and a second winding to generate a number of pole pairs that is larger by one or smaller by one than number of pole pairs of the magnetic flux generator, and
the magnetic sensors are three pairs of the magnetic sensors of a first sensor that is the magnetic sensor located between the first windings having the same phase and directions of energization opposite to each other, and between the second windings having different phases, and a second sensor that is the magnetic sensor located between the first windings having the same phase and directions of energization opposite to each other, and between the second windings having different phases and having a same combination of phases of the second windings located on both sides of the first sensor.

13. A motor comprising:
a rotor in which a magnetic flux generator that generates a magnetic flux is disposed;
a stator including a back yoke disposed facing the rotor, and a plurality of teeth protruding from the back yoke toward the rotor and disposed at intervals in a circumferential direction;
a winding wound around the stator; and
a plurality of magnetic sensors provided in slots that are spaces between adjacent ones of the teeth, wherein
the winding includes a first winding to generate a number of pole pairs equal to number of pole pairs of the magnetic flux generator, and a second winding to generate a number of pole pairs that is larger by one or smaller by one than number of pole pairs of the magnetic flux generator, and
the magnetic sensors are three pairs of the magnetic sensors of a first sensor that is the magnetic sensor located between the first windings having the same phase and directions of energization opposite to each other, and between the second windings having the same phase and directions of energization opposite to each other, and a second sensor that is the magnetic sensor located between the first windings having the same phase and directions of energization opposite to each other, and between the second windings having the same phase and directions of energization opposite to each other.

14. The motor according to claim 12, wherein
the winding includes one that generates a number of pole pairs equal to number of pole pairs of the magnetic flux generator.

15. The motor according to claim 12, wherein
the magnetic sensor is disposed inside the slot and closer to the back yoke than a tip of the teeth.

16. The motor according to claim 13, wherein
the magnetic sensor is disposed inside the slot and closer to the back yoke than a tip of the teeth.

17. The motor according to claim 12, wherein
number of the slots is a multiple of six that is twelve or more, and
number of pole pairs of the magnetic flux generator and number of pole pairs generated by the winding are larger than ⅓ times the number of slots and smaller than ⅔ times the number of slots.

18. The motor according to claim 13, wherein
number of the slots is a multiple of six that is twelve or more, and
number of pole pairs of the magnetic flux generator and number of pole pairs generated by the winding are larger than ⅓ times the number of slots and smaller than ⅔ times the number of slots.

19. A motor system comprising the motor according to claim 12 and a control circuitry to control the motor, wherein
the control circuitry includes
a computation circuitry to obtain a rotation angle and/or an eccentricity of the rotor based on signals of the plurality of magnetic sensors, and
the computation circuitry computes a sum of or a difference between a signal of the first sensor and a signal of the second sensor of the three pairs of magnetic sensors.

20. A motor system comprising the motor according to claim 13 and a control circuitry to control the motor, wherein
the control circuitry includes
a computation circuitry to obtain a rotation angle and/or an eccentricity of the rotor based on signals of the plurality of magnetic sensors, and
a signal of the magnetic sensor used by the computation circuitry is a signal of the first sensor and the second sensor of the three pairs of magnetic sensors.

21. The motor system according to claim 19, wherein
the winding includes one that generates a number of pole pairs equal to number of pole pairs of the magnetic flux generator.

22. The motor system according to claim 19, wherein
the magnetic sensor is disposed inside the slot and closer to the back yoke than a tip of the teeth.

23. The motor system according to claim 20, wherein
the magnetic sensor is disposed inside the slot and closer to the back yoke than a tip of the teeth.

24. The motor system according to claim 20, wherein
the computation circuitry computes a sum of or a difference between a signal of the first sensor and a signal of the second sensor in each of the pair of the magnetic sensors.

25. The motor system according to claim 19, wherein
number of the slots is a multiple of six that is twelve or more, and
number of pole pairs of the magnetic flux generator and number of pole pairs generated by the winding are larger than ⅓ times the number of slots and smaller than ⅔ times the number of slots.

26. The motor system according to claim 20, wherein
number of the slots is a multiple of six that is twelve or more, and
number of pole pairs of the magnetic flux generator and number of pole pairs generated by the winding are larger than ⅓ times the number of slots and smaller than ⅔ times the number of slots.

27. The motor system according to claim 19, wherein
the control circuitry further includes:
a storage circuitry to store information indicating a relationship between the energization amount and a change amount of a signal of the magnetic sensor, the relationship being obtained from a signal of the magnetic sensor acquired when the energization amount of the winding is changed; and
a correction circuitry to correct a signal of the magnetic sensor based on the relationship between the energization amount and the change amount of the signal of the magnetic sensor indicated by the information stored in the storage circuitry.

28. The motor system according to claim 20, wherein
the control circuitry further includes:
a storage circuitry to store information indicating a relationship between the energization amount and a change amount of a signal of the magnetic sensor, the relationship being obtained from a signal of the magnetic sensor acquired when the energization amount of the winding is changed; and
a correction circuitry to correct a signal of the magnetic sensor based on the relationship between the energization amount and the change amount of the signal of the magnetic sensor indicated by the information stored in the storage circuitry.
